(19) United States
(12) Patent Application Publication
(10) Pub. No.: US 2012/0176685 A1
(43) Pub. Date: Jul. 12, 2012

(54) REFRACTIVE, VARIABLE MAGNIFICATION OPTICAL SYSTEM

(75) Inventor: Setsu Sato, Saitama (JP)

(73) Assignee: TAMRON CO., LTD.

(21) Appl. No.: 13/302,420

(22) Filed: Nov. 22, 2011

(30) Foreign Application Priority Data
Jan. 7, 2011 (JP) 2011-001927

(51) Int. Cl. G02B 15/14

(52) U.S. Cl. 359/684

(57) ABSTRACT

A refractive, variable magnification optical system comprising, sequentially from a side nearest an object, a first lens group having a positive refractive power; a second lens group having a negative refractive power; a third lens group having a positive refractive power; and a fourth lens group having a positive refractive power. The first lens group includes sequentially from the side nearest the object, a negative meniscus lens having a convex surface facing toward the object, a prism that refracts an optical path, a plano-convex lens, and a biconvex lens, a light transmitting surface of the prism and the plano-convex lens being cemented. The third lens group 3 includes the aperture stop ST. The fourth lens group includes a meniscus lens that has a concave surface facing toward an image plane and is disposed nearest the image plane, among the lenses of the fourth lens group.

### BACKGROUND OF THE INVENTION

1. Field of the Invention

The present invention relates to a compact refractive optical system having high optical performance and suitable for compact imaging apparatuses.

2. Description of the Related Art

Accompanying demand for smaller imaging apparatuses, smaller imaging lenses mounted to the imaging apparatuses are also demanded. In response to this demand, a refractive optical system has been proposed that disposes in the optical path, a prism that refracts the optical path, thereby enabling a reduction in a dimension of depth (thickness) of the optical system. Consequently, by employing this refractive optical system, the thickness of the imaging device is also reduced. However, in recent years, in addition to the demand for even thinner digital cameras equipped with a refractive optical system, wider angles of view and higher resolution are also demanded. Further, with the correction of chromatic difference of magnification and distortion becoming possible via software applications, optical systems that assume the correction of aberration via software applications are also demanded. Consequently, optical systems capable of meeting such demands have also emerged (for example, refer to Japanese Patent Laid-Open Publication No. 2008-250135).

Although the optical system recited in Japanese Patent Laid-Open Publication No. 2008-250135 is compact, since numerous resin lenses are used, the optical system is easily affected by temperature changes such as those caused by the heat emitted by components such as an image sensor. For example, if the surrounding temperature increases, displacement of the image plane may occur consequent to thermal expansion of the lens.

In general, resin lenses are difficult to cut. For example, when a resin lens is formed “rectangularly” by an injection molding process, creating the shape of a proper lens surface is difficult.

Furthermore, the prism and the lens disposed near the image side of the prism are separate in the optical system recited in Japanese Patent Laid-Open Publication No. 2008-250135. Consequently, light reflected at a lower aspect of the prism may enter the optical path on the image side, resulting in ghosting.

### SUMMARY OF THE INVENTION

It is an object of the present invention to at least solve the above problems in the conventional technologies.

A refractive, variable magnification optical system according to one aspect of the invention includes, sequentially from a side nearest an object, a first lens group having a positive refractive power; a second lens group having a negative refractive power; a third lens group having a positive refractive power; and a fourth lens group having a positive refractive power.

The first lens group includes sequentially from the side nearest the object, a negative meniscus lens having a convex surface facing toward the object, a prism that refracts an optical path, a plano-convex lens, and a biconvex lens, a light transmitting surface of the prism and the plano-convex lens being cemented. The third lens group 3 includes the aperture stop ST. The fourth lens group includes a meniscus lens that has a concave surface facing toward an image plane and is disposed nearest the image plane, among the lenses of the fourth lens group.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a diagram of the refractive, variable magnification optical system according to an embodiment of the present invention;

FIG. 2 is a cross sectional view (along the optical axis) of the refractive, variable magnification optical system according to a first example;

FIG. 3 is a diagram of aberration occurring at the wide angle edge of the refractive, variable magnification optical system according to the first example;

FIG. 4 is a diagram of aberration occurring at the intermediate edge of the refractive, variable magnification optical system according to the first example;

FIG. 5 is a diagram of aberration occurring at the telephoto edge of the refractive, variable magnification optical system according to the first example;

FIG. 6 is a cross sectional view (along the optical axis) of the refractive, variable magnification optical system according to a second example;

FIG. 7 is a diagram of aberration occurring at the wide angle edge of the refractive, variable magnification optical system according to the second example;

FIG. 8 is a diagram of aberration occurring at the intermediate edge of the refractive, variable magnification optical system according to the second example;

FIG. 9 is a diagram of aberration occurring at the telephoto edge of the refractive, variable magnification optical system according to the second example;

FIG. 10 is a cross sectional view (along the optical axis) of the refractive, variable magnification optical system according to a third example;

FIG. 11 is a diagram of aberration occurring at the wide angle edge of the refractive, variable magnification optical system according to the third example;

FIG. 12 is a diagram of aberration occurring at the intermediate edge of the refractive, variable magnification optical system according to the third example;

FIG. 13 is a diagram of aberration occurring at the telephoto edge of the refractive, variable magnification optical system according to the third example;

FIG. 14 is a cross sectional view (along the optical axis) of the refractive, variable magnification optical system according to a fourth example;

FIG. 15 is a diagram of aberration occurring at the wide angle edge of the refractive, variable magnification optical system according to the fourth example;

FIG. 16 is a diagram of aberration occurring at the intermediate edge of the refractive, variable magnification optical system according to the fourth example; and

FIG. 17 is a diagram of aberration occurring at the telephoto edge of the refractive, variable magnification optical system according to the fourth example.

### DETAILED DESCRIPTION OF THE PREFERRED EMBODIMENTS

Referring to the accompanying drawings, exemplary embodiments according to the present invention are explained in detail below.

Referring to the accompanying drawings, exemplary embodiments of a refractive, variable magnification optical system according to the present invention are explained in detail below.

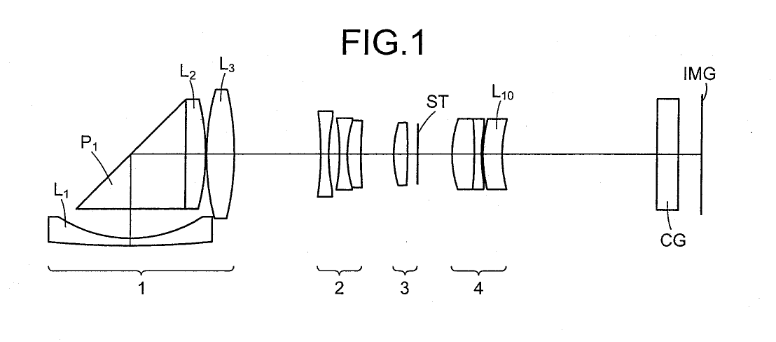

FIG. 1 is a diagram of the refractive, variable magnification optical system according to an embodiment of the present invention. The refractive, variable magnification optical system includes sequentially from a side nearest the object (not depicted), a first lens group 1 having a positive refractive power, a second lens group 2 having a negative refractive power, a third lens group 3 having a positive refractive power, and a fourth lens group 4 having a positive refractive power. Further, a cover glass CG is disposed between the fourth lens group 4 and an image plane IMG. The refractive, variable magnification optical system zooms from the wide angle edge to the telephoto edge by moving the second lens group 2 along the optical axis, from the object side toward the image plane IMG side; and performs focusing by moving the fourth lens 4 along the optical axis. The first lens group 1 and the third lens group 3 are fixed.

The first lens group 1 includes sequentially from the object side, negative meniscus lens L₁ having a convex surface facing toward the object, a prism P₁ that refracts the optical path, a plano-convex lens L₂, and a biconvex lens L₃. A light transmitting surface of the prism P₁ and the plano-convex lens L₂ are cemented. The third lens group 3 is configured to include an aperture stop ST. Although FIG. 1 depicts an example where the aperture stop ST is disposed on the image side of a lens making up the third lens group 3, provided the aperture stop ST is near the lens, the aperture stop ST may be disposed on the object side of the lens. A meniscus lens L₁₀ having a concave surface on the image plane side is disposed nearest the image plane IMG, among the lenses of the fourth lens group 4.

By disposing the negative meniscus lens L₁ (which has a convex surface on the object side) nearest the object among the lenses of the first lens group 1, the occurrence of various types of aberration, such as distortion, can be suppressed. The prism P₁, the plano-convex lens L₂, and the biconvex lens L₃ are disposed subsequent to the meniscus lens L₁, and by cementing the light transmitting surface of the prism P₁ and the plano-convex lens L₂, a shortening of a dimension of depth (thickness) of the optical system is enabled and the occurrence of ghosting consequent to light reflected at a lower aspect of the prism P₁ can be suppressed. Further, by disposing the meniscus lens L₁₀ (which has a concave surface on the image plane IMG side) nearest the image plane IMG, among the lenses of the fourth lens group 4, coma that is in an opposite direction to that of the coma caused by the meniscus lens L₁ is created by the meniscus lens L₁₀, enabling cancellation of the coma caused by the meniscus lens L₁.

An object of the present invention is to provide a refractive, variable magnification optical system that is resistant to temperature changes, is thin and compact, and offers high optical performance at wide angles. To further assure achievement of the object, in addition to the characteristics above, the following conditions are further set with respect to the present invention.

The refractive, variable magnification optical system according to the present embodiment preferably satisfies the following conditional expressions, where NdG03 is the refractive index at the d-line of the plano-convex lens L₂ in the first lens group 1, NdG04 is the refractive index at the d-line of the biconvex lens L₃ in the first lens group 1, νdG03 is the Abbe number for the d-line of the plano-convex lens L₂ in the first lens group 1, and νdG04 is the Abbe number for the d-line of the biconvex lens L₃ in the first lens group 1.

NdG03>NdG04 (1)

NdG04≦1.65 (2)

νdG03<νdG04 (3)

νdG04≧70 (4)

Satisfaction of conditional expression (1) to (4) corrects, in a balanced manner, longitudinal chromatic aberration occurring at the telephoto edge of the refractive, variable magnification optical system and chromatic difference of magnification occurring at the wide angle edge, enabling improvement of the imaging performance of the optical system.

The refractive, variable magnification optical system according to the embodiment preferably satisfies the following conditional expressions, where G01R02 is the radius of curvature of the surface on the image plane IMG side of the lens (meniscus lens 1) disposed nearest the object, among the lenses of the first lens group 1; fG01 is the focal length of the lens (meniscus lens 1) disposed nearest the object, among the lenses of the first lens group 1; and G11R01 is the radius of curvature of the surface on the object side of the lens (meniscus lens L₁₀) disposed nearest the image plane IMG among the lenses of the fourth lens group 4.

−0.6>G01R02/fG01>−0.9 (5)

−1.1>G11R01/fG01>−1.7 (6)

Satisfaction of conditional expression (5) and (6) accurately corrects coma of the intermediate image height occurring at the telephoto edge of the refractive, variable magnification optical system, and enables radial distortion occurring at the wide angle edge to be prevented. If the refractive, variable magnification optical system is outside either one of the ranges prescribed by conditional expressions (5) and (6), the correction of coma of the intermediate image height occurring at the telephoto edge becomes difficult, or radial distortion at the wide angle occurs. In particular, an occurrence of radial distortion invites a drop in the modulation transfer function (MTF).

Further, in the refractive, variable magnification optical system, a meniscus-shaped cemented lens is may be disposed on the object side of the meniscus lens L₁₀ in the fourth lens group 4. By such a configuration, correction of the coma occurring at the meniscus lens L₁ can be performed by the cemented lens in place of the meniscus lens L₁₀. In this manner, correction of the coma at the meniscus lens L₁ can be assumed by the cemented lens, whereby the axial shift tolerance of the meniscus lens L₁₀ can be less strict, facilitating optical system design.

The refractive, variable magnification optical system according to the embodiment preferably satisfies the conditional expressions below, where FT is the focal length of the entire optical system, at the telephoto edge; FAT is the combined focal length of the first lens group 1 to the third lens group 3, at the telephoto edge; F1 is the focal length of the first lens group 1; FW is the focal length of the entire optical system, at the wide angle edge; and Fe is the focal length of the lens (meniscus lens L₁₀) disposed nearest the image plane IMG, among the lenses of the fourth lens group 4.

−0.09<FT/FAT<0.09 (7)

2.0<F1/FW≦3.0 (8)

FW/Fe=0 (9)

Conditional expression (7) prescribes a condition for preventing deterioration of optical performance during focusing. Satisfaction of conditional expression (7) enables effective correction of various types of aberration that occur during focusing. Outside the range prescribed by conditional expression (7), aberration that occurs during focusing becomes prominent and is thus, not desirable.

Conditional expression (8) expresses a condition for reducing the overall length of the optical system and for correcting, in a balanced manner, longitudinal chromatic aberration occurring at the telephoto edge and chromatic difference of magnification occurring at the wide angle edge. Satisfaction of conditional expression (8) enables the refractive, variable magnification optical system to correct, in a balanced manner, longitudinal chromatic aberration occurring at the telephoto edge and chromatic difference of magnification occurring at the wide angle edge and further enables the overall length of the optical system to be reduced. Below the lower limit of conditional expression (8), the overall length of the optical system cannot be reduced and is thus, not desirable. On the other hand, above the upper limit of conditional expression (8), longitudinal chromatic aberration occurring at the telephoto edge and chromatic difference of magnification occurring at the wide angle edge become prominent and is thus, not desirable.

Conditional expression (9) expresses a condition for making the tolerance of the surface intervals of lens (meniscus lens L₁₀) disposed nearest the image plane IMG, among the lenses of the fourth lens group 4, less strict. By satisfying conditional expression (9), the paraxial refractive power of the meniscus lens L₁₀ becomes 0, thereby enabling the surface interval tolerance of the meniscus lens L₁₀ to be less strict and thus, facilitating optical system design. When Fe=0, then FW=∞. Satisfaction of conditional expressions (7) to (9) facilitates design and enables a compact refractive, variable magnification optical system having high optical performance to be provided.

In the refractive, variable magnification optical system according to the embodiment, the lenses of the first lens group 1, the third lens group 3, and the fourth lens group 4 may be made of a glass material. Further, the first lens group 1 includes a large diameter lens to enable a greater wide-angle view. The first lens group 1 further includes the prism P₁, whereby the optical path is refracted, facilitating contact of the outer peripheral portions of the meniscus lens L₁ and the biconvex lens L₃, and attempts to prevent this contact may be detrimental to reducing the dimension of depth (thickness) of the optical system. Thus, to prevent such disadvantages, a D-cut of the lens is necessary, the use of a lens formed by a glass material, which is easy to form the D-cut, is preferable. Forming each of the lenses of the first lens group 1 of a glass material facilitates the D-cut of the meniscus lens L₁ and the biconvex lens L₃. By implementing a D-cut of meniscus lens L₁ and biconvex lens L₃, the outer peripheral portions of the meniscus lens L₁ and the biconvex lens L₃, which are disposed on the refracted optical path, can be prevented from interfering with one another, fostering a reduction in the thickness of the optical system. On the other hand, since the third lens group 3 and the fourth lens group 4 are relatively close to the image sensor, which is a source of heat, the third lens group 3 and the fourth lens group 4 are configured by lenses made of a glass material, which is resistant to temperature changes, thereby enabling displacement of the image plane consequent to thermal expansion of the lenses to be prevented. Of course, all of the lens groups may be configured by lenses made of a glass material.

In the refractive, variable magnification optical system, the lens disposed nearest the object, among the lenses of the second lens group 2 may be made of a resin material. The lens disposed nearest the object, among the lenses of the second lens group 2 need not be subject to the D-cut for enabling a shape having a smaller effective diameter and since the lenses are disposed away from the heat generating image sensor, the lenses are not susceptible to temperature changes. Therefore, by forming the lens of a resin material, the manufacturing cost can be reduced. A further advantage is that when an aspheric surface has to be formed on a lens, a resin lens facilitates formation of an aspheric surface.

As described, the refractive, variable magnification optical system according to the embodiment has the characteristics described above, thereby forming a thin and compact refractive, variable magnification optical system having high optical performance at a wide-angle view. In particular, by satisfying the conditional expressions above, imaging performance can be further improved. Further, making each of the lenses configuring the first lens group 1 of a glass material facilitates further reduction of thickness of the optical system. By additionally making each of the lenses configuring the third lens group 3 and the fourth lens group 4, which are susceptible to the effects of heat, of a glass material, displacement of the image plane consequent to thermal expansion of the lenses can be prevented.

Hereinafter, examples of the refractive, variable magnification optical system according to the present invention will be described in detail with reference to the accompanying drawings. The present invention is not limited by the following examples.

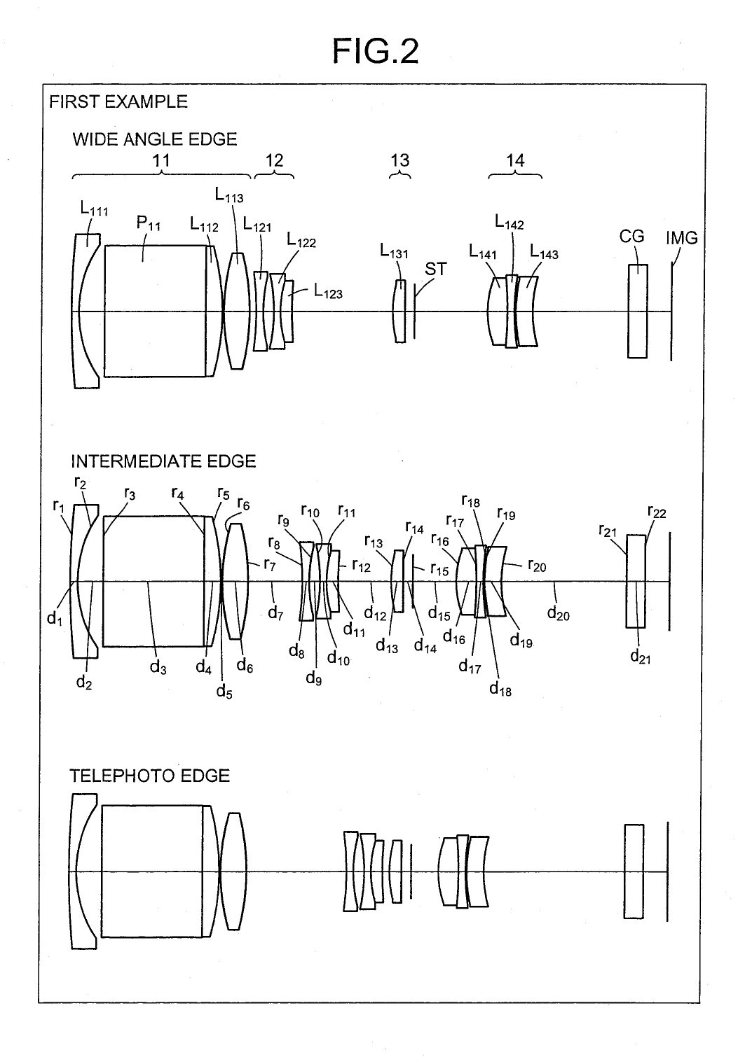

FIG. 2 is a cross sectional view (along the optical axis) of the refractive, variable magnification optical system according to a first example. The refractive, variable magnification optical system includes sequentially from a side nearest the object (not depicted), a first lens group 11 having a positive refractive power, a second lens group 12 having a negative refractive power, a third lens group 13 having a positive refractive power, and a fourth lens group 14 having a positive refractive power. Further, the cover glass CG is disposed between the fourth lens group 14 and the image plane IMG. The cover glass CG is disposed as needed and when not necessary, may be omitted. Further, at the image plane IMG, the optical receiving surface of the image sensor, such as a CCD, CMOS, etc. is disposed.

The first lens group 11 includes sequentially from the object side, a negative meniscus lens L₁₁₁ having a convex surface facing toward the object, a prism P₁₁ that refracts the optical path, a plano-convex lens L₁₁₂, and a biconvex lens L₁₁₃. The light transmitting surface of the prism P₁₁ and the plano-convex lens L₁₁₂ are cemented. The meniscus lens L₁₁₁, the plano-convex lens L₁₁₂, and the biconvex lens L₁₁₃ are made of a glass material and have a D-cut. Further, the surface of the object side of the meniscus lens L₁₁₁ and of the biconvex lens L₁₁₃ are aspheric, respectively.

The second lens group 12 includes sequentially from the object side, a negative lens L₁₂₁, a negative lens L₁₂₂, and a positive lens L₁₂₃. These lenses are each made of a glass material. The negative lens L₁₂₂ and the positive lens L₁₂₃ are cemented. Further, the surface of the object side of the negative lens L₁₂₁ is aspheric.

The third lens group 13 includes sequentially from the object side, a positive lens L₁₃₁ and the aperture stop ST of a prescribed diameter. The positive lens L₁₃₁ is made of a glass material. Further, the surface of the object side of the positive lens L₁₃₁ is aspheric.

The fourth lens group 14 includes a positive lens L₁₄₁, a negative lens L₁₄₂, and a meniscus lens L₁₄₃ having a concave surface facing toward the image plane IMG. These lenses are each made of a glass material. The positive lens L₁₄₁ and the negative lens L₁₄₂ are cemented and collectively have a meniscus shape. Further, the surface of the object side of the meniscus lens L₁₄₃ is aspheric.

The refractive, variable magnification optical system zooms from the wide angle edge to the telephoto edge by moving the second lens group 12 along the optical axis, from the object side toward the image plane IMG side; and performs focusing by moving the fourth lens group 14 along the optical axis. The first lens group 11 and the third lens group 13 are fixed.

Various values related to the refractive, variable magnification optical system according to the first example are indicated below.

Focal length=5.2 (FW: wide angle edge) to 8.98 (intermediate edge) to 16.16 (FT: telephoto edge)
F-number=3.64 (wide angle edge) to 4.00 (intermediate edge) to 4.24 (telephoto edge)
Angle of view (2ω)=72.2° (wide angle edge) to 46.2° (intermediate edge) to 25.64° (telephoto edge)

### (Values Related to Conditional Expressions (1) to (4))

Refractive index at d-line of plano-convex lens L₁₁₂ (NdG03)=1.75
Refractive index at d-line of biconvex lens L₁₁₃ (NdG04)=1.50

### (∴NdG03>NdG04, NdG04≦1.55)

Abbe number for d-line of plano-convex lens L₁₁₂ (νdG03)=52.32
Abbe number for d-line of biconvex lens L₁₁₃ (νdG04)=81.61 (∴νdG03<νdG04, νdG04≧70)

### (Values Related to Conditional Expressions (5) and (6))

Radius of curvature of image plane IMG side of meniscus lens L₁₁₁ (G01R02)=9.04
Focal length of meniscus lens L₁₁₁ (fG01)=−11.13
Radius of curvature of object side of meniscus lens L₁₄₃ (G11R01)=17.72
G01R02/fG01=−0.81
G11R01/fG01=−1.59

### (Values Related to Conditional Expressions (7) to (9))

Combined focal length of first lens group 11 to third lens 13 group, at telephoto edge (FAT)=198.8
Focal length of first lens group 11 (F1)=13.02
Focal length of meniscus lens L₁₄₃ (Fe)=1×10⁶⁹

### FT/FAT=0.081

### F1/FW=3

### FW/Fe=0

r₁=86.60 (aspheric surface)

d₁=0.50 nd₁=1.90 νd₁=31.01

r₂=9.04

d₂=1.91

r₃=∞ (prism surface)

d₃=7.30 nd₂=1.90 νd₂=31.32

r₄=∞

d₄=1.27 nd₃=1.75 νd₃=52.32

r₅=−16.08

d₅=0.10

r₆=13.73 (aspheric surface)

d₆=1.86 nd₄=1.50 νd₄=81.61

r₇=−21.75

d₇=0.5 (wide angle edge) to 3.936 (intermediate edge) to 7.317 (telephoto edge)

r₈=−14.71 (aspheric surface)

d₈=0.50 nd₅=1.52 νd₅=64.07

r₉=13.45

d₉=0.76

r₁₀=−13.01

d₁₀=0.50 nd₆=1.84 νd₆=42.98

r₁₁=7.55

d₁₁=0.84 nd₇=1.92 νd₇=18.90

r₁₂=30.58

d₁₂=7.317 (wide angle edge) to 3.855 (intermediate edge) to 0.5 (telephoto edge)

r₁₃=7.48 (aspheric surface)

d₁₃=0.90 nd₈=1.50 νd₈=81.56

r₁₄=−50.61

d₁₄=0.70

r₁₅=∞ (aperture stop)

d₁₅=5.293 (wide angle edge) to 3.152 (intermediate edge) to 1.975 (telephoto edge)

r₁₆=6.93

d₁₆=1.46 nd₉=1.74 νd₉=44.79

r₁₇=−29.87

d₁₇=0.50 nd₁₀=1.95 νd₁₀=17.98

r₁₈=17.90

d₁₈=0.10

r₁₉=17.72 (aspheric surface)

d₁₉=1.23 nd₁₁=1.52 νd₁₁=64.07

r₂₀=17.72

d₂₀=7 (wide angle edge) to 9.141 (intermediate edge) to 10.318 (telephoto edge)

r₂₁=∞

d₂₁=1.40 nd₁₂=1.52 νd₁₂=64.14

r₂₂=∞
Constant of the cone (ε) and aspheric coefficients (A, B, C, D, E, F, G, H, I)

(First Plane)

ε=23.366,

### A=0, B=0,

### C=2.062111×10⁻⁶, D=1.074871×10⁻⁶,

### E=2.102009×10⁻⁸, F=1.275181×10⁻⁹,

### G=−3.936452×10⁻¹¹, H=0,

### I=0

(Sixth Plane)

δ=0.703,

### A=0, B=−1.784580×10⁻⁵,

### C=−1.687408×10⁻⁴, D=−6.085992×10⁻⁶,

### E=−1.244994×10⁻⁷, F=−1.863924×10⁻⁹,

### G=2.560434×10⁻¹⁰, H=−9.172798×10⁻¹²,

### I=0

(Eighth Plane)

ε=−46.267,

### A=0, B=0,

### C=5.594144×10⁻⁴, D=−6.314570×10⁻⁵,

### E=−2.321334×10⁻⁸, F=6.996445×10⁻⁸,

### G=2.360671×10⁻⁸, H=0,

### I=0

(Thirteenth Plane)

ε=1.457,

### A=0, B=0,

### C=−1.035791×10⁻⁴, D=2.808004×10⁻⁶,

### E=4.999901×10⁻⁶, F=2.229841×10⁻⁶,

### G=−8.607045×10⁻⁸, H=0,

### I=0

(Nineteenth Plane)

ε=23.397,

### A=0, B=0,

### C=2.233456×10⁻³, D=1.116136×10⁻⁵,

### E=−3.810640×10⁻⁸, F=5.491464×10⁻⁸,

### G=−3.588824×10⁻⁸, H=0,

### I=0

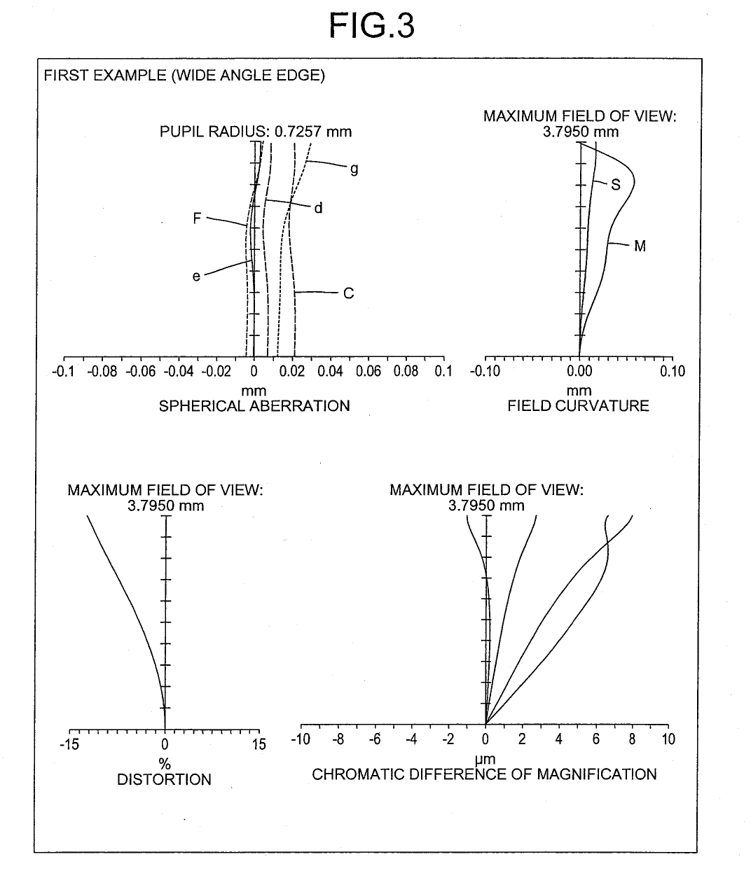

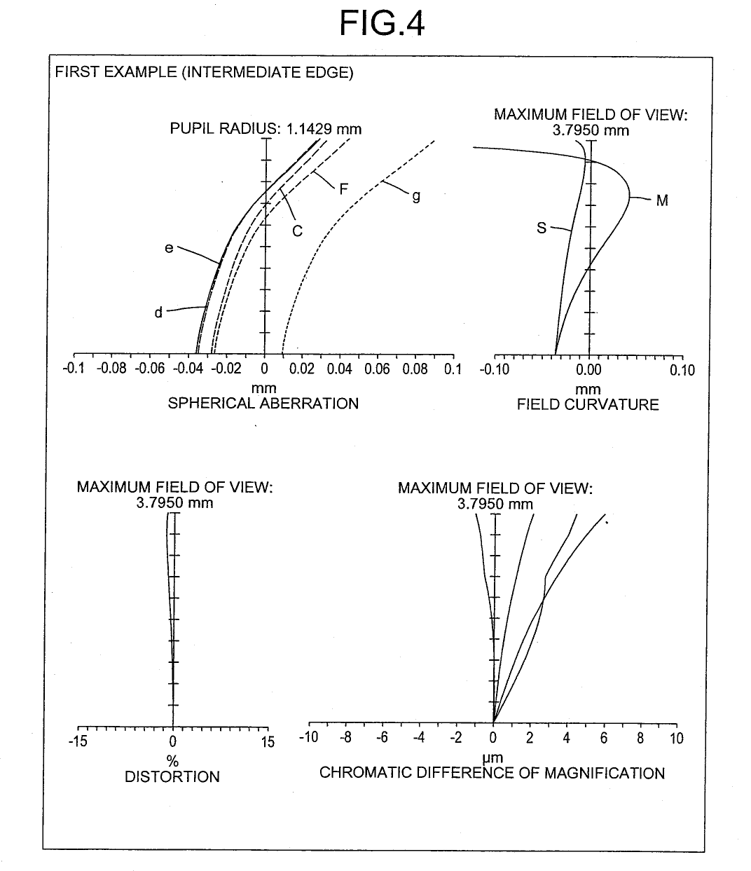

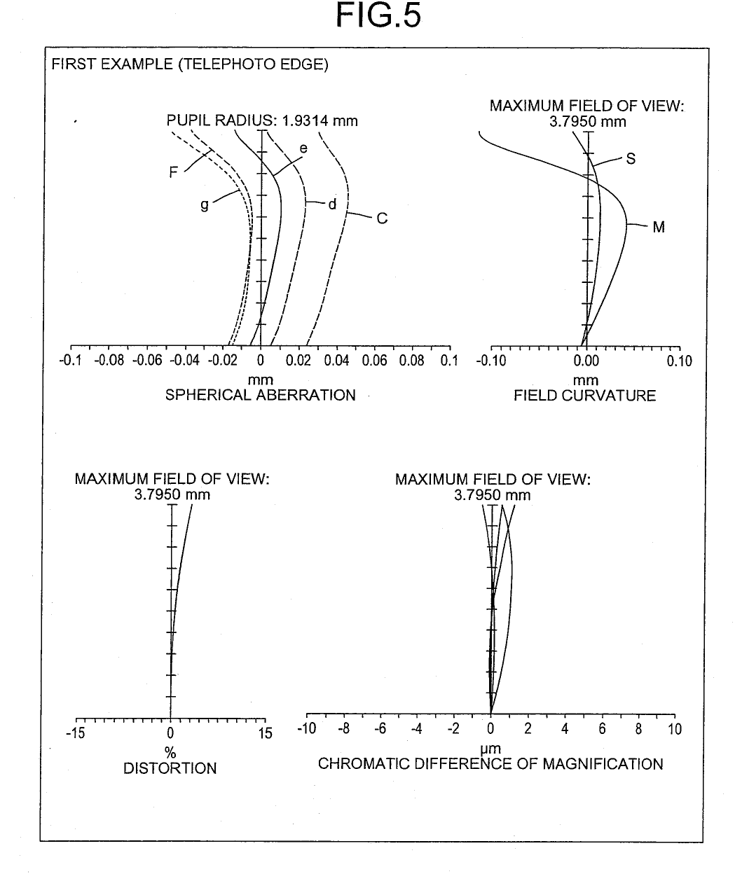

FIG. 3 is a diagram of aberration occurring at the wide angle edge of the refractive, variable magnification optical system according to the first example. FIG. 4 is a diagram of aberration occurring at the intermediate edge of the refractive, variable magnification optical system according to the first example. FIG. 5 is a diagram of aberration occurring at the telephoto edge of the refractive, variable magnification optical system according to the first example. In the diagrams, d indicates chromatic aberration corresponding to the d-line (λ=588 nm), g indicates chromatic aberration corresponding to the g-line (λ=436 nm), F indicates chromatic aberration corresponding to the F-line (λ=486 nm), C indicates chromatic aberration corresponding to the C-line (λ=656 nm), and e indicates chromatic aberration corresponding to the e-line (λ=546 nm). Reference numerals S and M in a field of curvature diagram indicate aberration for the sagittal plane and the meridonal plane, respectively.

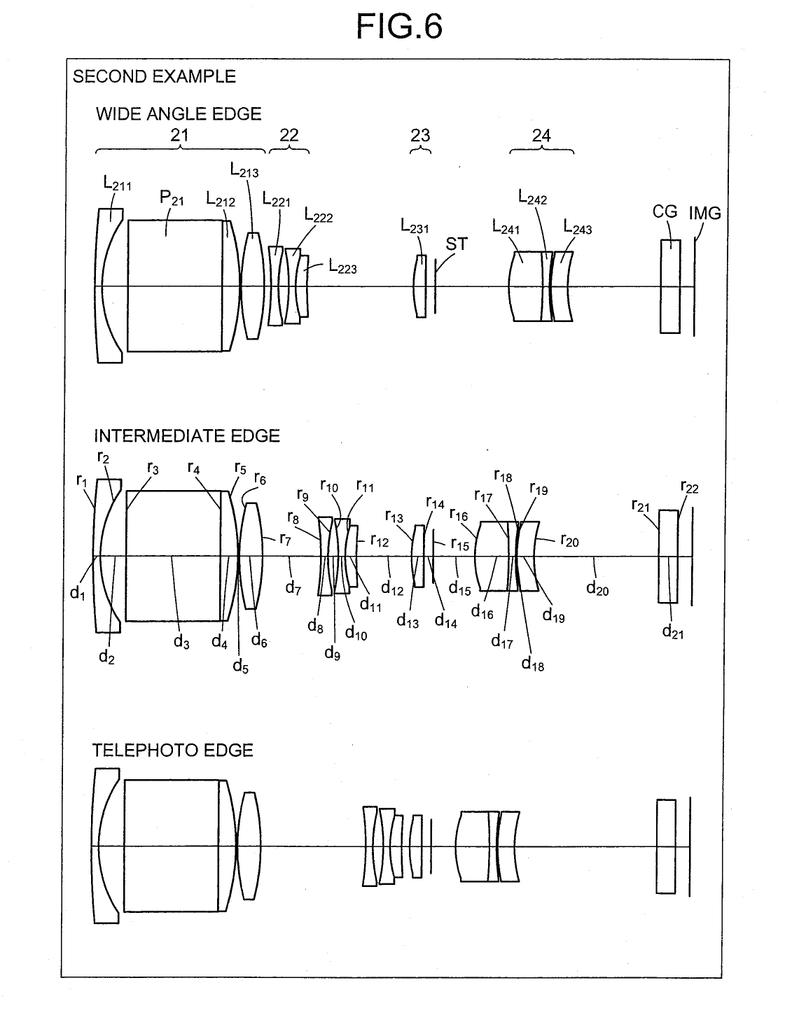

FIG. 6 is a cross sectional view (along the optical axis) of the refractive, variable magnification optical system according to a second example. The refractive, variable magnification optical system includes sequentially from a side nearest the object (not depicted), a first lens group 21 having a positive refractive power, a second lens group 22 having a negative refractive power, a third lens group 23 having a positive refractive power, and a fourth lens group 24 having a positive refractive power Further, the cover glass CG is disposed between the fourth lens group 24 and the image plane IMG. The cover glass CG is disposed as needed and when not necessary, may be omitted. Further, at the image plane IMG, the optical receiving surface of the image sensor, such as a CCD, CMOS, etc. is disposed.

The first lens group 21 includes sequentially from the object side, a negative meniscus lens L₂₁₁ having a convex surface facing toward the object, a prism P₂₁ that refracts the optical path, a plano-convex lens L₂₁₂, and a biconvex lens L₂₁₃. The light transmitting surface of the prism P₂₁ and the plano-convex lens L₂₁₂ are cemented. The meniscus lens L₂₁₁, the plano-convex lens L₂₁₂, and the biconvex lens L₂₁₃ are made of a glass material and have a D-cut. Further, the surface of the object side of the meniscus lens L₂₁₁ and of the biconvex lens L₂₁₃ are aspheric, respectively.

The second lens group 22 includes sequentially from the object side, a negative lens L₂₂₁, a negative lens L₂₂₂, and a positive lens L₂₂₃. These lenses are each made of a glass material. The negative lens L₂₂₂ and the positive lens L₂₂₃ are cemented. Further, the surface of the object side of the negative lens L₂₂₁ is aspheric.

The third lens group 23 includes sequentially from the object side, a positive lens L₂₃₁ and the aperture stop ST of a prescribed diameter. The positive lens L₂₃₁ is made of a glass material. Further, the surface of the object side of the positive lens L₂₃₁ is aspheric.

The fourth lens group 24 includes a positive lens L₂₄₁, a negative lens L₂₄₂, and a meniscus lens L₂₄₃ having a concave surface facing toward the image plane IMG. These lenses are each made of a glass material. The positive lens L₂₄₁ and the negative lens L₂₄₂ are cemented and collectively have a meniscus shape. Further, the surface of the object side of the meniscus lens L₂₄₃ is aspheric.

The refractive, variable magnification optical system zooms from the wide angle edge to the telephoto edge by moving the second lens group 22 along the optical axis, from the object side toward the image plane IMG side; and performs focusing by moving the fourth lens group 24 along the optical axis. The first lens group 21 and the third lens group 23 are fixed.

Various values related to the refractive, variable magnification optical system according to the second example are indicated below.

Focal length=5.08 (FW: wide angle edge) to 9.66 (intermediate edge) to 18.57 (FT: telephoto edge)
F-number=3.62 (wide angle edge) to 4.09 (intermediate edge) to 4.398 (telephoto edge)
Angle of view (2ω)=73.5° (wide angle edge) to 42.88° (intermediate edge) to 23.10° (telephoto edge)

### (Values Related to Conditional Expressions (1) to (4))

Refractive index at d-line of plano-convex lens L₂₁₂ (NdG03)=1.75
Refractive index at d-line of biconvex lens L₂₁₃ (NdG04)=1.50

### (∴NdG03>NdG04, NdG04≦1.55)

Abbe number for d-line of plano-convex lens L₂₁₂ (νdG03)=52.32
Abbe number for d-line of biconvex lens L₂₁₃ (νdG04)=81.61 (∴νdG03<νdG04, νdG04≧70)

### (Values Related to Conditional Expressions (5) and (6))

Radius of curvature of image plane IMG side of meniscus lens L₂₁₁ (G01R02)=9.42
Focal length of meniscus lens L₂₁₁ (fG01)=−11.84
Radius of curvature of object side of meniscus lens L₂₄₃ (G11R01)=14.48
G01R02/fG01=−0.80
G11R01/fG01=−1.22

### (Values Related to Conditional Expressions (7) to (9))

Combined focal length of first lens group 21 to third lens group 23, at telephoto edge (FAT)=−930.5
Focal length of first lens group 21 (F1)=13.447
Focal length of meniscus lens L₂₄₃ (Fe)=1×10⁵⁶

### FT/FAT=−0.020

### F1/FW=3

### FW/Fe=0

r₁=77.43 (aspheric surface)

d₁=0.50 nd₁=1.90 νd₁=31.01

r₂=9.42

d₂=2.11

r₃=∞ (prism surface)

d₃=7.30 nd₂=1.90 νd₂=31.32

r₄=∞

d₄=1.32 nd₃=1.75 νd₃=52.32

r₅=−16.91

d₅=0.1

r₆=14.09 (aspheric surface)

d₆=1.79 nd₄=1.50 νd₄=81.61

r₇=−22.64

d₇=0.5 (wide angle edge) to 4.528 (intermediate edge) to 8.184 (telephoto edge)

r₈=−14.42 (aspheric surface)

d₈=0.50 nd₅=1.52 νd₅=64.07

r₉=13.55

d₉=0.81

r₁₀=−12.92

d₁₀=0.50 nd₆=1.84 νd₆=42.98

r₁₁=8.09

d₁₁=1.10 nd₇=1.92 νd₇=18.90

r₁₂=31.29

d₁₂=8.184 (wide angle edge) to 4.17 (intermediate edge) to 0.5 (telephoto edge)

r₁₃=8.31 (aspheric surface)

d₁₃=0.91 nd₈=1.50 νd₈=81.56

r₁₄=−55.24

d₁₄=0.70

r₁₅=∞ (aperture stop)

d₁₈=5.776 (wide angle edge) to 3.207 (intermediate edge) to 1.923 (telephoto edge)

r₁₆=7.25

d₁₆=2.70 nd₉=1.74 νd₉=44.79

r₁₇=−22.37

d₁₇=0.50 nd₁₀=1.95 νd₁₀=17.98

r₁₈=19.70

d₁₈=0.10

r₁₉=14.48 (aspheric surface)

d₁₉=1.23 nd₁₁=1.52 νd₁₁=64.07

r₂₀=14.48

d₂₀=7.35 (wide angle edge) to 9.19 (intermediate edge) to 11.27 (telephoto edge)

r₂₁=∞

d₂₁=1.50 nd₁₂=1.52 νd₁₂=64.14

r₂₂=∞
Constant of the cone (δ) and aspheric coefficients (A, B, C, D, E, F, G, H, I)

(First Plane)

ε=49.286,

### A=0, B=0,

### C=5.13831×10⁻⁶, D=6.59077×10⁻⁷,

### E=4.07767×10⁻⁹, F=8.99232×10⁻¹⁰,

### G=1.75806×10⁻¹¹, H=0,

### I=0

(Sixth Plane)

ε=0.863,

### A=0, B=0,

### C=−1.723238×10⁻⁴, D=2.940574×10⁻⁶,

### E=8.824989×10⁻⁸, F=3.626982×10⁻⁹,

### G=3.961153×10⁻¹⁰, H=0,

### I=0

(Eighth Plane)

ε=−44.618,

### A=0, B=0,

### C=6.211540×10⁻⁴, D=4.358065×10⁻⁵,

### E=−3.974179×10⁻⁷, F=1.512230×10⁻⁷,

### G=−3.702931×10⁻⁹, H=0,

### I=0

(Thirteenth Plane)

ε=3.019,

### A=0, B=0,

### C=−2.254315×10⁻⁴, D=2.930539×10⁻⁵,

### E=5.091106×10⁻⁶, F=1.398557×10⁻⁶,

### G=8.629026×10⁻⁸, H=0,

### I=0

(Nineteenth Plane)

ε=20.610,

### A=0, B=0,

### C=1.776220×10⁻³, D=−1.214843×10⁻⁴,

### E=5.125124×10⁻⁶, F=1.909264×10⁻⁶,

### G=2.648721×10⁻⁷, H=0,

### I=0

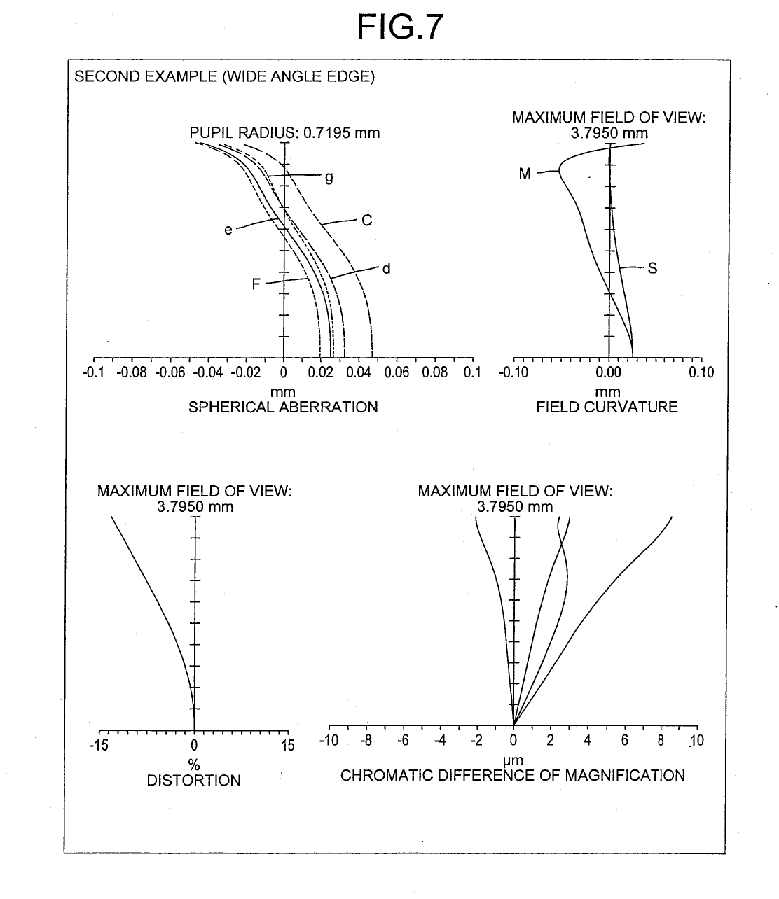

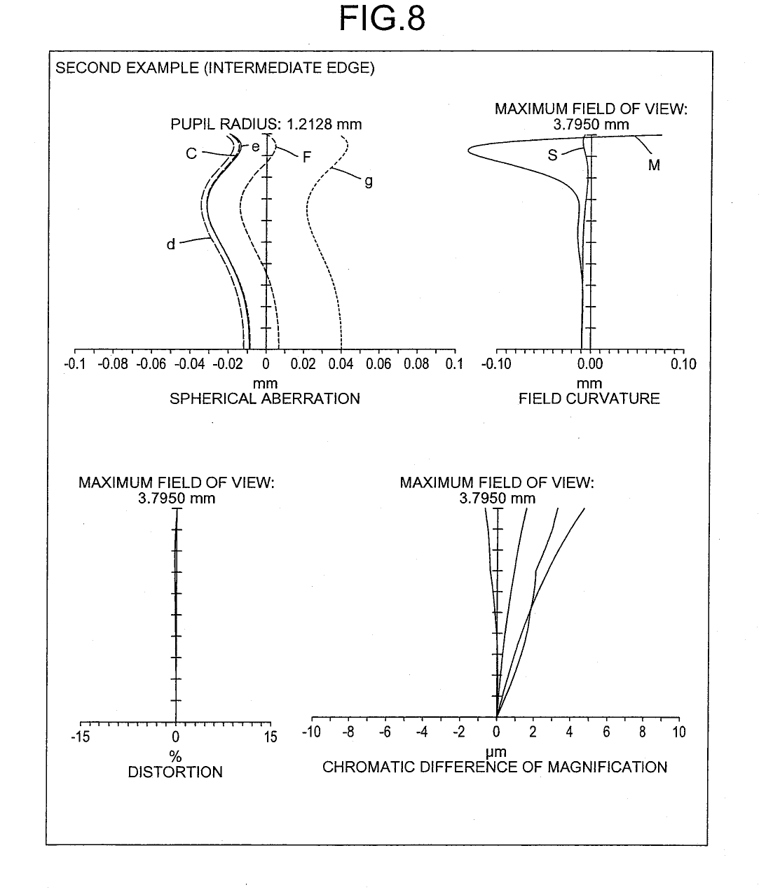

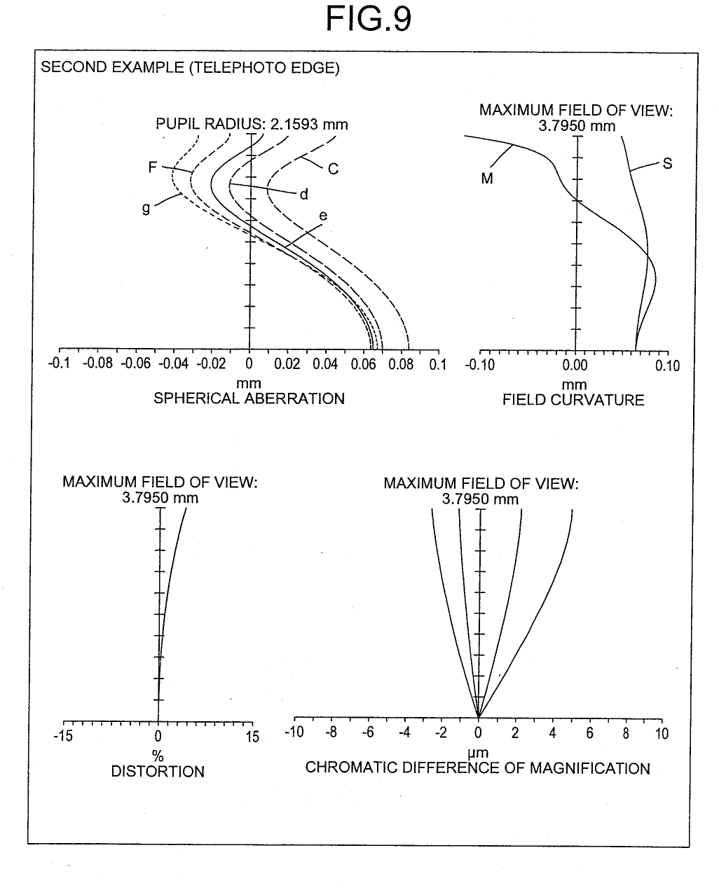

FIG. 7 is a diagram of aberration occurring at the wide angle edge of the refractive, variable magnification optical system according to the second example. FIG. 8 is a diagram of aberration occurring at the intermediate edge of the refractive, variable magnification optical system according to the second example. FIG. 9 is a diagram of aberration occurring at the telephoto edge of the refractive, variable magnification optical system according to the second example. In the diagrams, d indicates chromatic aberration corresponding to the d-line (λ=588 nm), g indicates chromatic aberration corresponding to the g-line (λ=436 nm), F indicates chromatic aberration corresponding to the F-line (λ=486 nm), C indicates chromatic aberration corresponding to the C-line (λ=656 nm), and e indicates chromatic aberration corresponding to the e-line (λ=546 nm). Reference numerals S and M in a field of curvature diagram indicate aberration for the sagittal plane and the meridonal plane, respectively.

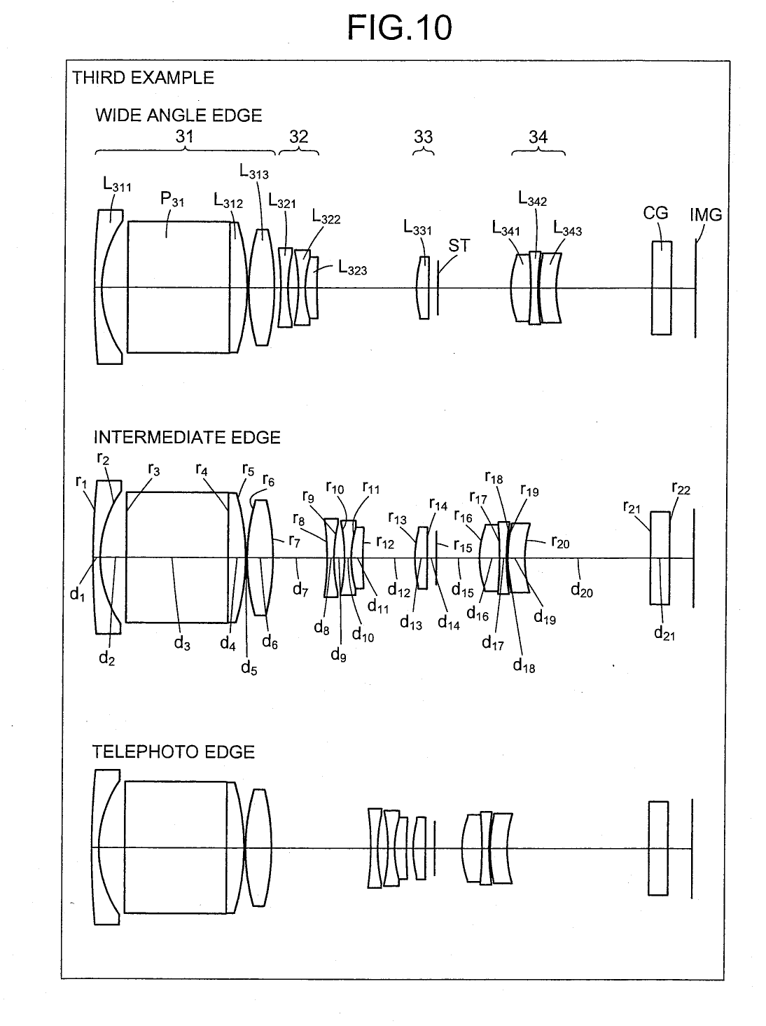

FIG. 10 is a cross sectional view (along the optical axis) of the refractive, variable magnification optical system according to a third example. The refractive, variable magnification optical system includes sequentially from a side nearest the object (not depicted), a first lens group 31 having a positive refractive power, a second lens group 32 having a negative refractive power, a third lens group 33 having a positive refractive power, and a fourth lens group 34 having a positive refractive power. Further, the cover glass CG is disposed between the fourth lens group 34 and the image plane IMG. The cover glass CG is disposed as needed and when not necessary, may be omitted. Further, at the image plane IMG, the optical receiving surface of the image sensor, such as a CCD, CMOS, etc. is disposed.

The first lens group 31 includes sequentially from the object side, a negative meniscus lens L₃₁₁ having a convex surface facing toward the object, a prism P₃₁ that refracts the optical path, a plano-convex lens L₃₁₂, and a biconvex lens L₃₁₃. The light transmitting surface of the prism P₃₁ and the plano-convex lens L₃₁₂ are cemented. The meniscus lens L₃₁₁, the plano-convex lens L₃₁₂, and the biconvex lens L₃₁₃ are made of a glass material and have a D-cut. Further, the surface of the object side of the meniscus lens L₃₁₁ and of the biconvex lens L₃₁₃ are aspheric, respectively.

The second lens group 32 includes sequentially from the object side, a negative lens L₃₂₁, a negative lens L₃₂₂, and a positive lens L₃₂₃. These lenses are each made of a glass material. The negative lens L₃₂₂ and the positive lens L₃₂₃ are cemented. Further, the surface of the object side of the negative lens L₃₂₁ is aspheric.

The third lens group 33 includes sequentially from the object side, a positive lens L₃₃₁ and the aperture stop ST of a prescribed diameter. The positive lens L₃₃₁ is made of a glass material. Further, the surface of the object side of the positive lens L₃₃₁ is aspheric.

The fourth lens group 34 includes a positive lens L₃₄₁, a negative lens L₃₄₂, and a meniscus lens L₃₄₃ having a concave surface facing toward the image plane IMG. These lenses are each made of a glass material. The positive lens L₃₄₁ and the negative lens L₃₄₂ are cemented and collectively have a meniscus shape. Further, the surface of the object side of the meniscus lens L₃₄₃ is aspheric.

The refractive, variable magnification optical system zooms from the wide angle edge to the telephoto edge by moving the second lens group 32 along the optical axis, from the object side toward the image plane IMG side; and performs focusing by moving the fourth lens group 34 along the optical axis. The first lens group 31 and the third lens group 33 are fixed.

Various values related to the refractive, variable magnification optical system according to the third example are indicated below.

Focal length=5.03 (FW: wide angle edge) to 8.87 (intermediate edge) to 16.14 (FT: telephoto edge)
F-number=3.62 (wide angle edge) to 3.96 (intermediate edge) to 4.16 (telephoto edge)
Angle of view (2ω)=76.37° (wide angle edge) to 46.4° (intermediate edge) to 25.54° (telephoto edge)

### (Values Related to Conditional Expressions (1) to (4))

Refractive index at d-line of plano-convex lens L₃₁₂ (NdG03)=1.75
Refractive index at d-line of biconvex lens L₃₁₃ (NdG04)=1.50

### (∴NdG03>NdG04, NdG04≦1.55)

Abbe number for d-line of plano-convex lens L₃₁₂ (νdG03)=52.32
Abbe number for d-line of biconvex lens L₃₁₃ (νdG04)=81.61 (∴νdG03<νdG04, νdG04≧70)

### (Values Related to Conditional Expressions (5) and (6))

Radius of curvature of image plane IMG side of meniscus lens L₃₁₁ (G01R02)=8.956
Focal length of meniscus lens L₃₁₁ (fG01)=−11.14
Radius of curvature of object side of meniscus lens L₃₄₃ (G11R01)=16.737
G01R02/fG01=−0.80
G11R01/fG01=−1.50

### (Values Related to Conditional Expressions (7) to (9))

Combined focal length of first lens group 31 to third lens group 33, at telephoto edge (FAT)=309.3
Focal length of first lens group 31 (F1)=12.92
Focal length of meniscus lens L₃₄₃ (Fe)=1×10⁵⁶

### FT/FAT=0.052

### F1/FW=3

### FW/Fe=0

r₁=79.307 (aspheric surface)

d₁=0.50 nd₁=1.90 νd₁=31.01

r₂=8.956

d₂=2.01

r₃=∞ (prism surface)

d₃=7.20 nd₂=1.90 νd₂=31.32

r₄=∞

d₄=1.17 nd₃=1.75 νd₃=52.32

r₅=−16.105

d₅=0.10

r₆=13.566 (aspheric surface)

d₆=1.72 nd₄=1.50 νd₄=81.61

r₇=−21.767

d₇=0.5 (wide angle edge) to 4.061 (intermediate edge) to 7.486 (telephoto edge)

r₈=−14.933 (aspheric surface)

d₈=0.50 nd₅=1.52 νd₅=64.07

r₉=13.651

d₉=0.76

r₁₀=−12.761

d₁₀=0.50 nd₆=1.84 νd₆=42.98

r₁₁=7.843

d₁₁=0.96 nd₇=1.92 νd₇=18.90

r₁₂=30.112

d₁₂=7.486 (wide angle edge) to 3.924 (intermediate edge) to 0.5 (telephoto edge)

r₁₃=7.712 (aspheric surface)

d₁₃=0.90 nd₈=1.50 νd₈=81.56

r₁₄=−53.504

d₁₄=0.70

r₁₅=∞ (aperture stop)

d₁₅=5.244 (wide angle edge) to 3.169 (intermediate edge) to 2.153 (telephoto edge)

r₁₆=6.835

d₁₆=1.95 nd₉=1.73 νd₉=54.68

r₁₇=−23.633

d₁₇=0.50 nd₁₀=1.92 νd₁₀=20.88

r₁₈=18.632

d₁₈=0.10

r₁₉=16.737 (aspheric surface)

d₁₉=1.15 nd₁₁=1.52 νd₁₁=64.07

r₂₀=16.737

d₂₀=7.0 (wide angle edge) to 9.029 (intermediate edge) to 10.066 (telephoto edge)

r₂₁=∞

d₂₁=1.60 nd₁₂=1.52 νd₁₂=64.14

r₂₂=∞
Constant of the cone (ε) and aspheric coefficients (A, B, C, D, E, F, G, H, I)

(First Plane)

ε=48.833,

### A=0, B=0,

### C=4.763680×10⁻⁷, D=1.030896×10⁻⁶,

### E=3.576936×10⁻⁸, F=1.568245×10⁻⁹,

### G=−4.598832×10⁻¹¹, H=0,

### I=0

(Sixth Plane)

ε=0.709,

### A=0, B=−2.217521,

### C=−1.666536×10⁻⁴, D=−6.056760,

### E=−1.254824, F=−1.876774,

### G=2.520833×10⁻¹, H=−9.278857×10⁻¹,

### I=0

(Eighth Plane)

ε=−50.024,

### A=0, B=0,

### C=5.579515×10⁻⁴, D=−5.687555×10⁻⁵,

### E=1.036087×10⁻⁷, F=1.145889×10⁻⁷,

### G=6.271237×10⁻⁹, H=0,

### I=0

(Thirteenth Plane)

ε=0.957,

### A=0, B=0,

### C=−7.524246×10⁻⁶, D=1.639468×10⁻⁵,

### E=5.324911×10⁻⁶, F=1.755133×10⁻⁶,

### G=−2.774733×10⁻⁸, H=0,

### I=0

(Nineteenth Plane)

ε=20.468,

### A=0, B=0,

### C=2.158511×10⁻³, D=3.962780×10⁻⁷,

### E=−3.029426×10⁻⁶, F=1.478558×10⁻⁷,

### G=−6.775195×10⁻⁸, H=0,

### I=0

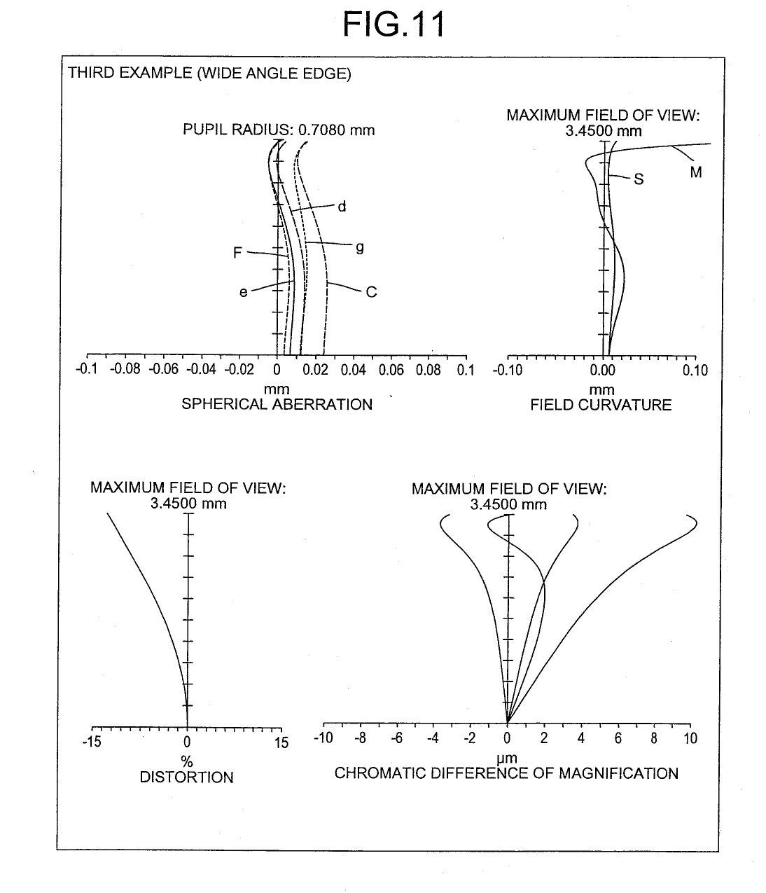

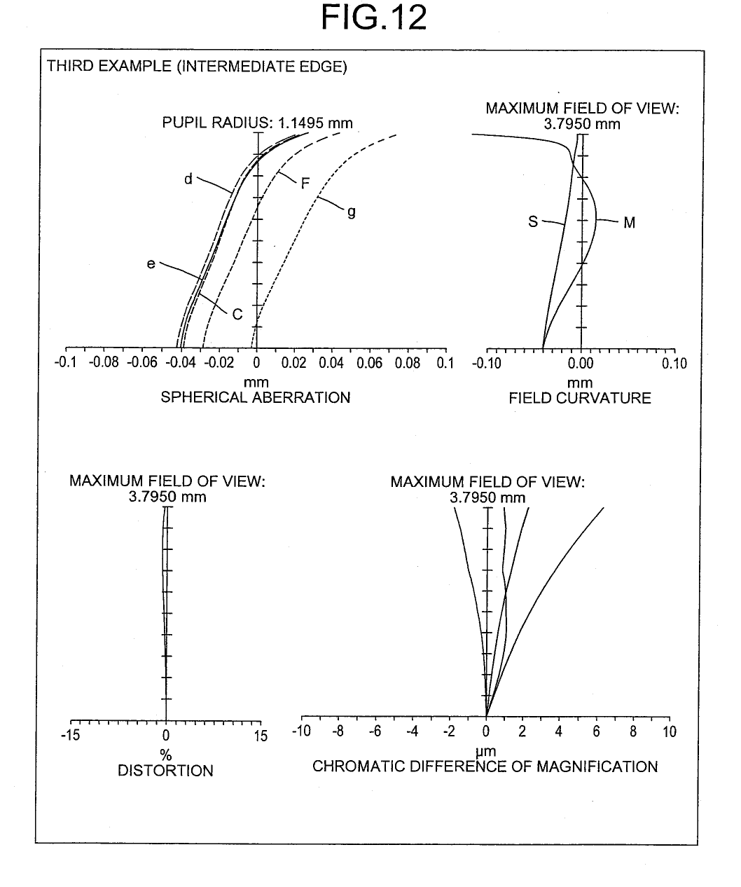

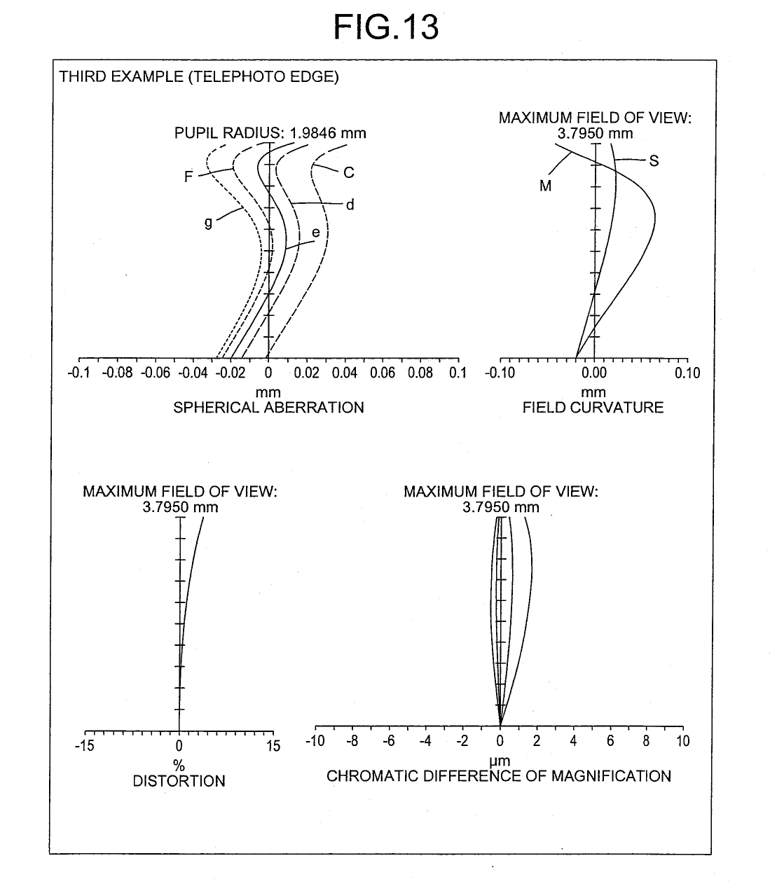

FIG. 11 is a diagram of aberration occurring at the wide angle edge of the refractive, variable magnification optical system according to the third example. FIG. 12 is a diagram of aberration occurring at the intermediate edge of the refractive, variable magnification optical system according to the third example. FIG. 13 is a diagram of aberration occurring at the telephoto edge of the refractive, variable magnification optical system according to the third example. In the diagrams, d indicates chromatic aberration corresponding to the d-line (λ=588 nm), g indicates chromatic aberration corresponding to the g-line (λ=436 nm), F indicates chromatic aberration corresponding to the F-line (λ=486 nm), C indicates chromatic aberration corresponding to the C-line (λ=656 nm), and e indicates chromatic aberration corresponding to the e-line (λ=546 nm). Reference numerals S and M in a field of curvature diagram indicate aberration for the sagittal plane and the meridonal plane, respectively.

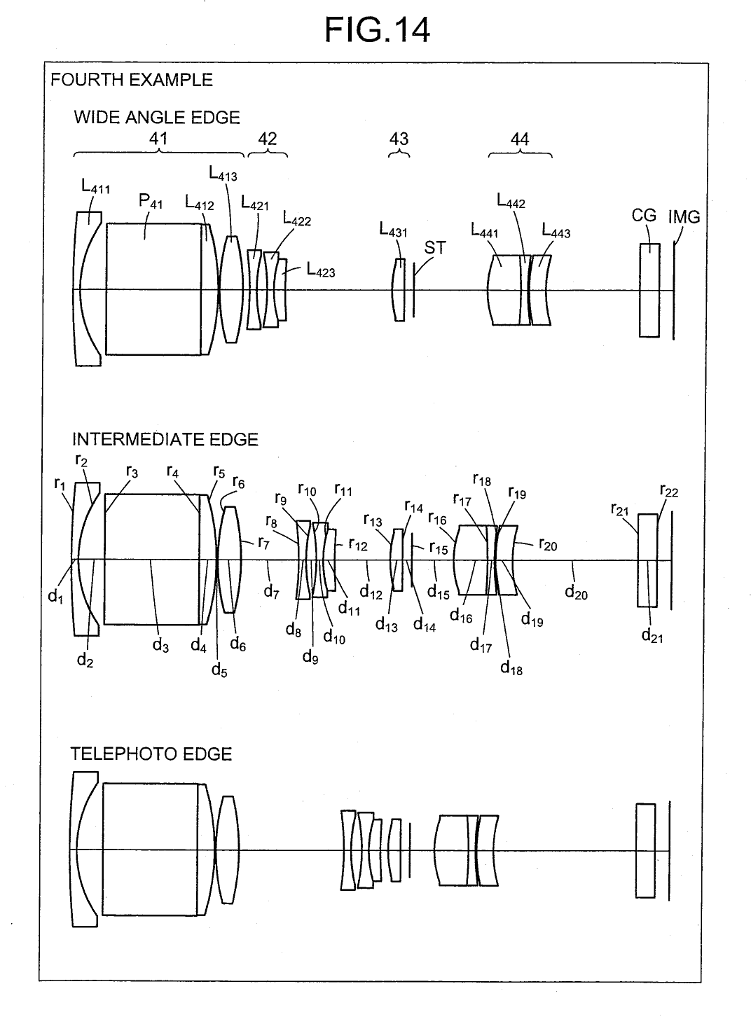

FIG. 14 is a cross sectional view (along the optical axis) of the refractive, variable magnification optical system according to a fourth example. The refractive, variable magnification optical system includes sequentially from a side nearest the object (not depicted), a first lens group 41 having a positive refractive power, a second lens group 42 having a negative refractive power, a third lens group 43 having a positive refractive power, and a fourth lens group 44 having a positive refractive power. Further, the cover glass CG is disposed between the fourth lens group 44 and the image plane IMG. The cover glass CG is disposed as needed and when not necessary, may be omitted. Further, at the image plane IMG, the optical receiving surface of the image sensor, such as a CCD, CMOS, etc. is disposed.

The first lens group 41 includes sequentially from the object side, a negative meniscus lens L₄₁₁ having a convex surface facing toward the object, a prism P₄₁ that refracts the optical path, a plano-convex lens L₄₁₂, and a biconvex lens L₄₁₃. The light transmitting surface of the prism P₄₁ and the plano-convex lens L₄₁₂ are cemented. The meniscus lens L₄₁₁, the plano-convex lens L₄₁₂, and the biconvex lens L₄₁₃ are made of a glass material and have a D-cut. Further, the surface of the object side of the meniscus lens L₄₁₁ and of the biconvex lens L₄₁₃ are aspheric, respectively.

The second lens group 42 includes sequentially from the object side, a negative lens L₄₂₁, a negative lens L₄₂₂, and a positive lens L₄₂₃. The negative lens L₄₂₁ is made of a resin material. The surface of the object side of the negative lens L₄₂₁ is aspheric. Further, the negative lens L₄₂₂ and the positive lens L₄₂₃ are made of a glass material and are cemented.

The third lens group 43 includes sequentially from the object side, a positive lens L₄₃₁ and the aperture stop ST of a prescribed diameter. The positive lens L₄₃₁ is made of a glass material. Further, the surface of the object side of the positive lens L₄₃₁ is aspheric.

The fourth lens group 44 includes a positive lens L₄₄₁, a negative lens L₄₄₂, and a meniscus lens L₄₄₃ having a concave surface facing toward the image plane IMG. These lenses are each made of a glass material. The positive lens L₄₄₁ and the negative lens L₄₄₂ are cemented and collectively have a meniscus shape. Further, the object the surface of meniscus lens L₄₄₃ is aspheric.

The refractive, variable magnification optical system zooms from the wide angle edge to the telephoto edge by moving the second lens group 42 along the optical axis, from the object side toward the image plane IMG side; and performs focusing by moving the fourth lens group 44 along the optical axis. The first lens group 41 and the third lens group 43 are fixed.

Various values related to the refractive, variable magnification optical system according to the fourth example are indicated below.

Focal length=5.17 (FW: wide angle edge) to 9.24 (intermediate edge) to 17.86 (FT: telephoto edge)
F-number=3.615 (wide angle edge) to 4.00 (intermediate edge) to 4.34 (telephoto edge)
Angle of view (2ω)=72.6° (wide angle edge) to 44.66° (intermediate edge) to 24.0° (telephoto edge)

### (Values Related to Conditional Expressions (1) to (4))

Refractive index at d-line of plano-convex lens L₄₁₂ (NdG03)=1.75
Refractive index at d-line of biconvex lens L₄₁₃ (NdG04)=1.50

### (∴NdG03>NdG04, NdG04≦1.55)

Abbe number for d-line of plano-convex lens L₄₁₂ (νdG03)=52.32
Abbe number for d-line of biconvex lens L₄₁₃ (νdG04)=81.56
(∴νdG03<νdG04, νdG04≧70)

### (Values Related to Conditional Expressions (5) and (6))

Radius of curvature of image plane IMG side of meniscus lens L₄₁₁ (G01R02)=9.38034
Focal length of meniscus lens L₄₁₁ (fG01)=−11.66
Radius of curvature of object side of meniscus lens L₄₄₃ (G11R01)=16.89632
G01R02/fG01=−0.80
G11R01/fG01=−1.45

### (Values Related to Conditional Expressions (7) to (9))

Combined focal length of first lens group 41 to third lens group 43, telephoto edge (FAT)=−218.1
Focal length of first lens group 41 (F1)=13.602
Focal length of meniscus lens L₄₄₃ (Fe)=1.00×10⁵⁶

### FT/FAT=−0.012

### F1/FW=3

### FW/Fe=0

r₁=83.41575 (aspheric surface)

d₁=0.50 nd₁=1.903 νd₁=31.01

r₂=9.38034

d₂=2.11

r₃=∞ (prism surface)

d₃=7.30 nd₂=1.904 νd₂=31.32

r₄=∞

d₄=1.34 nd₃=1.755 νd₃=52.32

r₅=−16.905

d₅=0.10

r₆=14.02305 (aspheric surface)

d₆=1.78 nd₄=1.497 νd₄=81.56

r₇=−23.09975

d₇=0.5 (wide angle edge) to 4.22 (intermediate edge) to 7.95 (telephoto edge)

r₈=−14.99747 (aspheric surface)

d₈=0.50 nd₅=1.531 νd₅=56.04

r₉=14.27307

d₉=0.81

r₁₀=−13.37338

d₁₀=0.50 nd₆=1.835 νd₆=42.71

r₁₁=8.17 95

d₁₁=1.04 nd₇=1.923 νd₇=18.90

r₁₂=31.29

d₁₂=7.950 (wide angle edge) to 4.236 (intermediate edge) to 0.5 (telephoto edge)

r₁₃=8.376189 (aspheric surface)

d₁₃=0.95 nd₈=1.497 νd₈=81.56

r₁₄=−47.99517

d₁₄=0.7

r₁₅=∞ (aperture stop)

d₁₅=5.616 (wide angle edge) to 3.376 (intermediate edge) to 2.091 (telephoto edge)

r₁₆=7.1925

d₁₆=2.39 nd₉=1.729 νd₉=54.68

r₁₇=−23.94

d₁₇=0.50 nd₁₀=1.923 νd₁₀=20.88

r₁₈=19.5027

d₁₈=0.10

r₁₉=16.89632 (aspheric surface)

d₁₉=1.21 nd₁₁=1.516 νd₁₁=64.07

r₂₀=16.89632

d₂₀=7.35 (wide angle edge) to 9.135 (intermediate edge) to 10.875 (telephoto edge)

r₂₁=∞

d₂₁=1.50 nd₁₂=1.516 νd₁₂=64.14

r₂₂=∞
Constant of the cone (ε) and aspheric coefficients (A, B, C, D, E, F, G, H, I)

(First Plane)

ε=23.034,

### A=0, B=0,

### C=1.00×10⁻⁷, D=4.66×10⁻⁸,

### E=7.83×10⁻⁹, F=9.06×10⁻¹⁰,

### G=6.01×10⁻¹², H=0,

### I=0

(Sixth Plane)

ε=1.030,

### A=0, B=0,

### C=0.000165869, D=9.85×10⁻⁷,

### E=1.10×10⁻⁷, F=7.10×10⁻¹⁰,

### G=2.05×10⁻¹¹, H=0,

### I=0

(Eighth Plane)

ε=−48.400,

### A=0, B=0,

### C=0.00058999, D=3.87×10⁻⁵,

### E=3.67×10⁻⁹, F=8.61×10⁻⁹,

### G=6.28×10⁻¹⁰, H=0,

### I=0

(Thirteenth Plane)

ε=2.805,

### A=0, B=0,

### C=−0.000133992, D=9.71×10⁻⁸,

### E=8.22×10⁻⁷, F=1.25×10⁻⁷

### G=5.22×10⁻⁹, H=0,

### I=0

(Nineteenth Plane)

ε=20.512,

### A=0, B=0,

### C=0.001854902, D=6.70×10⁻⁶,

### E=2.17×10⁻⁸, F=9.05×10⁻⁹,

### G=3.37×10⁻⁹, H=0,

### I=0

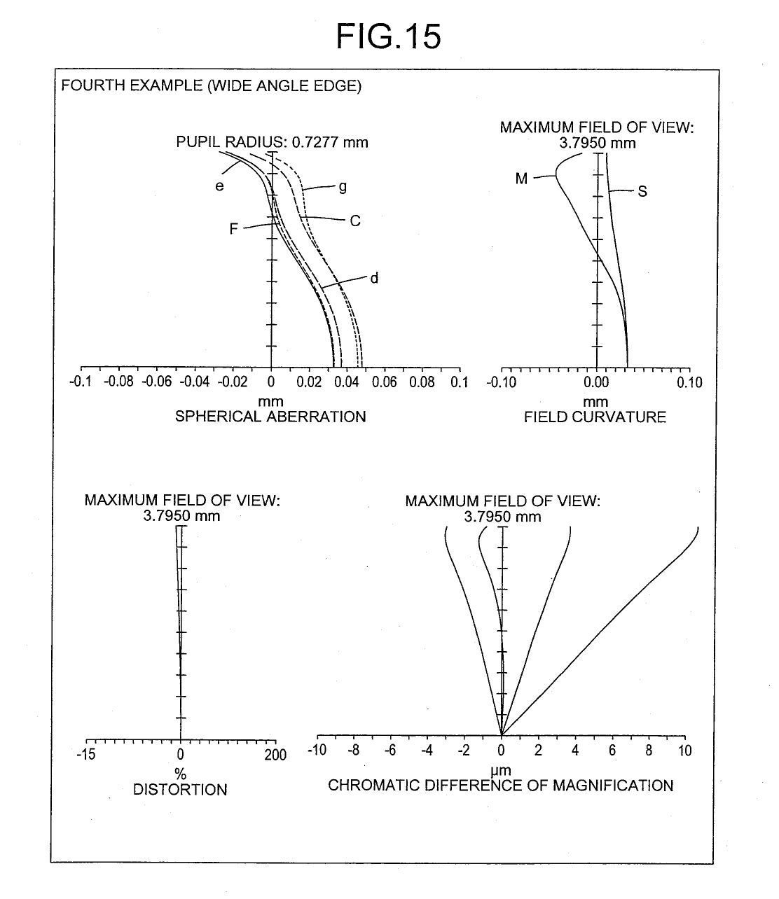

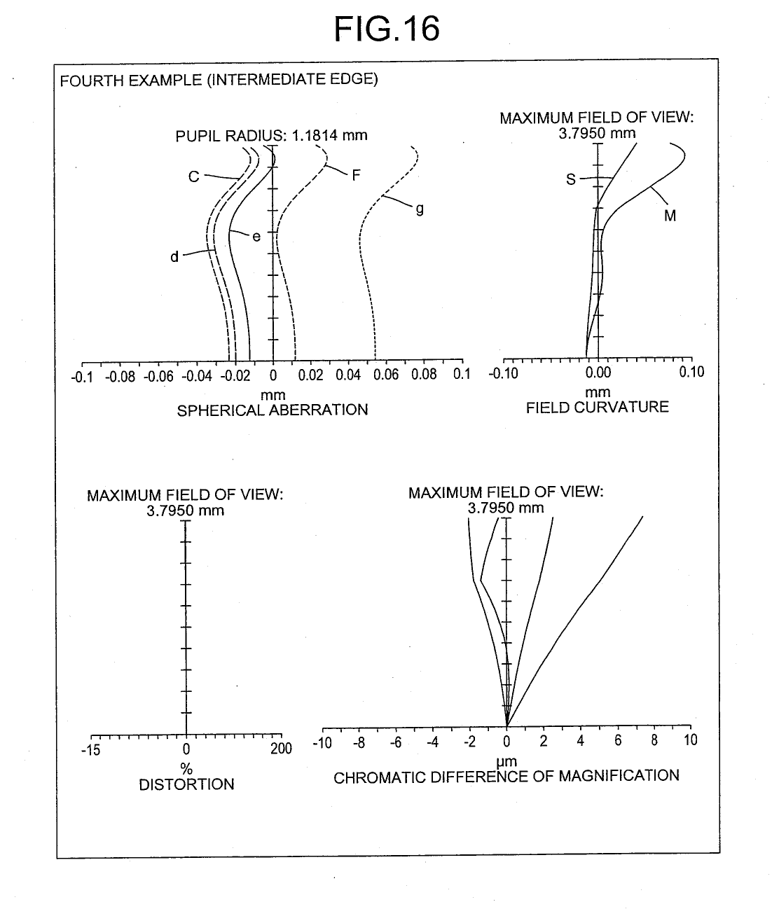

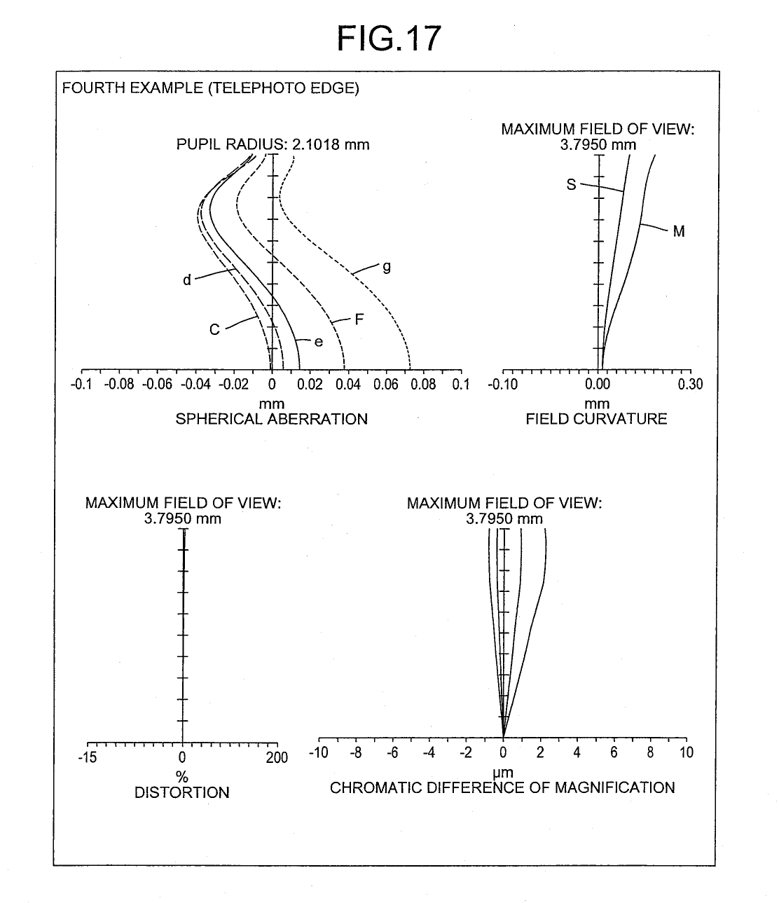

FIG. 15 is a diagram of aberration occurring at the wide angle edge of the refractive, variable magnification optical system according to the fourth example. FIG. 16 is a diagram of aberration occurring at the intermediate edge of the refractive, variable magnification optical system according to the fourth example. FIG. 17 is a diagram of aberration occurring at the telephoto edge of the refractive, variable magnification optical system according to the fourth example. In the diagrams, d indicates chromatic aberration corresponding to the d-line (λ=588 nm), g indicates chromatic aberration corresponding to the g-line (λ=436 nm), F indicates chromatic aberration corresponding to the F-line (λ=486 nm), C indicates chromatic aberration corresponding to the C-line (λ=656 nm), and e indicates chromatic aberration corresponding to the e-line (λ=546 nm). Reference numerals S and M in a field of curvature diagram indicate aberration for the sagittal plane and the meridonal plane, respectively.

Among the values for each of the examples above, r₁, r₂, . . . indicate radii of curvature for each lens, diaphragm surface, etc.; d₁, d₂, . . . indicate the thickness of the lenses, diaphragm, etc. or the distance between surfaces thereof; nd₁, nd₂, . . . indicate the refraction index of each lens with respect to the d-line; and νd₁, νd₂, . . . indicate the Abbe number with respect to the d-line of each lens.

Each aspheric surface shape above is expressed by equation [1], where the orientation of optical axis is parallel to the x axis, y is a height from the optical axis, and the traveling direction of light is assumed positive.

$$X = \frac{{y}^{2} / R}{1 + \sqrt{1 - ( ɛ {y}^{2} / {R}^{2} )}} + {Ay}^{2} + {By}^{3} + {Cy}^{4} + {Dy}^{6} + {Ey}^{8} + {Fy}^{10} + {Gy}^{12} + {Hy}^{14} + {Iy}^{16} \qquad [ 1 ]$$

Where, R is the paraxial radius of curvature, ε is the constant of the cone, A, B, C, D, E, F, G, H, and I are aspheric coefficients of the second plane, the third plane, the fourth plane, the sixth plane, the eighth plane, the tenth plane, the twelfth plane, the fourteenth plane, and the sixteen plane, respectively.

As described, since the refractive, variable magnification optical system according to each example has the characteristics described, each is a refractive, variable magnification optical system that is thin, compact and has high optical performance at a wide-angle view.

In other words, by disposing the negative meniscus lens (that has a convex surface facing toward the object) nearest the object, among the lenses of the first lens group, the occurrence of various types of aberration including distortion can be suppressed. Further, by disposing the prism (which refracts the optical path), the plano-convex lens, and the biconvex lens subsequent to the meniscus lens, and by cementing the light transmitting surface of the prism and the plano-convex lens to configure the first lens group, the dimension of depth (thickness) of the optical system can be reduced and ghosting consequent to reflected light at a lower aspect of the prism can be suppressed. Further, by disposing the meniscus lens (that has a concave surface facing toward the image) nearest the image, among the lenses of the fourth lens group, coma of the meniscus lens (which is in the opposite direction of the coma of the meniscus lens of the first lens group) can be used to cancel out the coma of the meniscus lens of the first lens group.

In particular, by satisfying each of the conditional expressions above, the refractive, variable magnification optical system can further improve imaging performance. Forming each of the lenses in the first lens group of a glass material facilitates further reduction of the dimension of depth (thickness) of the optical system. Further, forming each of the lenses of the third and the fourth lens groups, which are susceptible to the effects of heat, of a glass material, displacement of the image plane consequent to thermal expansion of the lenses can be prevented. Lenses that are not disposed at positions susceptible to the effects of heat may be made of a resin material. By including resin lenses, manufacturing cost can be reduced.

As necessary, the refractive, variable magnification optical system is includes lenses having an aspheric surface, enabling various types of aberration to be corrected by fewer lenses as well as reductions in the size, weight, and manufacturing cost of the optical system.

As described, the refractive, variable magnification optical system according to the present invention is applicable to compact imaging apparatuses such as portable information terminals and is particularly, suitable when high optical performance is demanded.

According to the present invention, a refractive, variable magnification optical system that is not susceptible to temperature changes, is thin and compact, and has high optical performance at wide-angle views, can be provided.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2011-001927 filed in Japan on Jan. 7, 2011.

What is claimed is:

1. A refractive, variable magnification optical system comprising, sequentially from a side nearest an object,
a first lens group having a positive refractive power;
a second lens group having a negative refractive power;
a third lens group having a positive refractive power; and
a fourth lens group having a positive refractive power, wherein
the first lens group includes sequentially from the side nearest the object, a negative meniscus lens having a convex surface facing toward the object, a prism that refracts an optical path, a plano-convex lens, and a biconvex lens, a light transmitting surface of the prism and the plano-convex lens being cemented,
the fourth lens group includes a meniscus lens that has a concave surface facing toward an image plane and is disposed nearest the image plane, among the lenses of the fourth lens group,
the second lens group moves along an optical axis, from the side nearest the object toward the image plane to zoom from a wide angle edge to a telephoto edge, and
the fourth lens group moves along the optical axis to perform focusing.

2. The refractive, variable magnification optical system according to claim 1, wherein the following conditional expressions are satisfied:
NdG03>NdG04 conditional expression (1)
NdG04≦1.65 conditional expression (2)
νdG03<νdG04 conditional expression (3)
νdG04≧70 conditional expression (4)
where, NdG03 is the refractive index at d-line of the plano-convex lens in the first lens group, NdG04 is the refractive index at the d-line of the biconvex lens in the first lens group, νdG03 is the Abbe number for the d-line of plano-convex lens in the first lens group, and νdG04 is the Abbe number for the d-line of the biconvex lens in the first lens group.

3. The refractive, variable magnification optical system according to claim 1, wherein the following conditional expressions are satisfied:
−0.6>G01R02/fG01>−0.9 conditional expression (5)
−1.1>G11R01/fG01>−1.7 conditional expression (6)
where, G01R02 is the radius of curvature of the surface on the image plane side of the lens disposed nearest the object, among the lenses of the first lens group; fG01 is the focal length of the lens disposed nearest the object, among the lenses of the first lens group; and G11R01 is the radius of curvature of the surface on the object side of the lens disposed nearest the image plane, among the lenses of the fourth lens group.

4. The refractive, variable magnification optical system according to claim 1, wherein the fourth lens group includes a cemented lens having a meniscus shape.

5. The refractive, variable magnification optical system according to claim 1, wherein the following conditional expressions are satisfied:
−0.09<FT/FAT<0.09 conditional expression (7)
2.0<F1/FW≦3.0 conditional expression (8)
FW/Fe=0 conditional expression (9)
where, FT is the focal length of the optical system, at the telephoto edge; FAT is the combined focal length of the first lens group to the third lens group, at the telephoto edge; F1 is the focal length of the first lens group; FW is the focal length of the optical system, at the wide angle edge; and Fe is the focal length of the lens disposed nearest the image plane, among the lenses of the fourth lens group.

6. The refractive, variable magnification optical system according to claim 1, wherein each lens of the first lens group, the third lens group, and the fourth lens group are made of a glass material.

7. The refractive, variable magnification optical system according to claim 1, wherein a lens nearest the object, among the lenses of the second lens group is made of a resin material.
